(19) United States
(12) Patent Application Publication
(10) Pub. No.: US 2002/0043205 A1
(43) Pub. Date: Apr. 18, 2002

(54) Magnetic apparatus

(76) Inventor: Paul Martin Frost, Nottingham (GB)

Correspondence Address: SMITH-HILL AND BEDELL, 12670 N W BARNES ROAD, SUITE 104, PORTLAND, OR, 97229

(21) Appl. No.: 09/915,977

(22) Filed: Jul. 25, 2001

(30) Foreign Application Priority Data
Jul. 25, 2000 (GB) 0018073.7

(51) Int. Cl. B60Q 11/00; H01F 7/20

(52) U.S. Cl. 116/28 R; 335/285

(57) ABSTRACT

Apparatus (20) comprising magnetic means in the form of a magnet (22) which is spaced in use from the surface of an object such as a roof R of an emergency Vehicle for example a police car or the like by resilient spacer means in the form of an “O” ring sealing member (24). The magnet (22) is connected to an article such as a light or siren (28) used by emergency services such that the light or siren (28) can be mounted on a vehicle V as required.

The present invention relates to magnetic apparatus removably mountable on an object and particularly but not exclusively to such apparatus mountable on vehicles.

Objects such as temporary sirens and lights for emergency services are typically mounted on vehicle bodies through the use of magnetic devices which are attached to the metallic body of the vehicle. However, such devices tend to be difficult to remove from the vehicle body when no longer required without causing damage to the vehicle.

According to the present invention there is provided magnetic apparatus removably mountable on an object, the apparatus comprising magnetic means and resilient means on the magnetic means to space the magnetic means from the object.

Preferably the resilient means is arranged to present no significant reduction in the surface area of the magnet means acting on the object. Preferably the resilient means is arranged to space the magnetic means from an object just sufficient to facilitate selective removal of the apparatus from an object, whilst allowing the magnetic forces acting to hold the apparatus on an object to remain sufficient to hold the apparatus in position on an object for use. Preferably the resilient means is arranged to provide for selective removal of apparatus from an object whilst acting to mitigate the possibility of damage to the object.

Preferably the resilient means is attached to the magnetic means, and may be removably attached.

The resilient means may comprise a sealing member. Preferably the sealing member is in the form of an “O” ring which may be located in use at or near to the periphery of a surface of the magnetic means which in use faces an object, Alternatively, the sealing member may comprise one or more annular sealing members extending from within said surface of the magnetic means.

Preferably a recess or other suitable formation is provided in the magnetic means to receive the resilient means.

Preferably the said surface of magnetic means comprises a control part comprising a magnetic pole, with an outer part, preferably concentric with and spaced from the central part and comprising the opposite magnetic pole.

The said recess may be defied between said central and outer parts.

The magnetic means may comprise a rare earth magnetic material, for example neodymium iron boron.

The apparatus may further include means for connecting an article to be mounted to the apparatus. The article may be removably connected to the apparatus or alternatively the article may be permanently connected to the apparatus.

The present invention further provides emergency indication apparatus, the apparatus comprising magnetic means according to any of the preceding paragraphs and emergency indication means.

Preferably the emergency indication means are in the form of an article such as a light or siren.

The emergency indication means are preferably releasably connected to the magnetic apparatus and may be releasably mountable onto an object such as the body of a vehicle.

The apparatus is preferably mountable onto a vehicle.

The present invention will now be described by way of example only with reference to the accompanying drawings, in which;

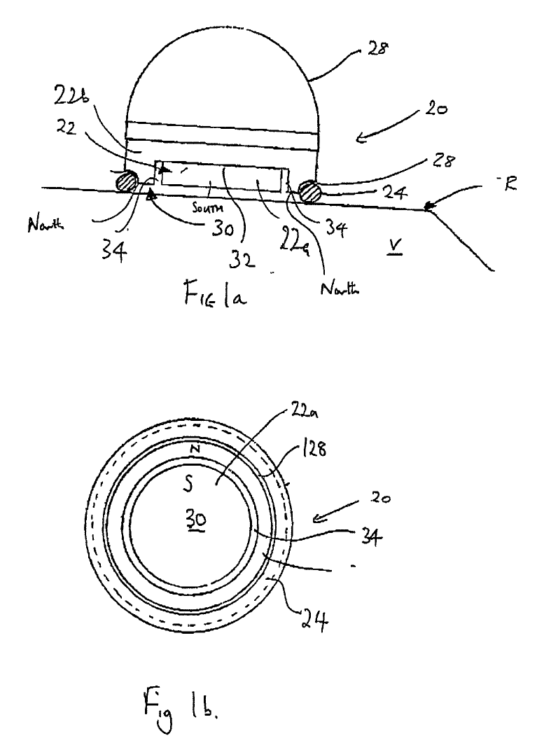

FIGS. 1a is a schematic Illustration of first apparatus according to the present invention in use;

FIG. 1b is a view from below the apparatus of FIG. 1a;

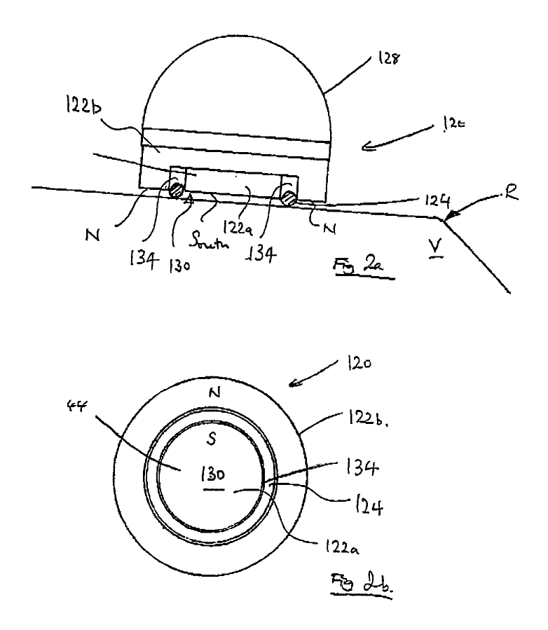

FIG. 2a is a schematic illustration of further apparatus according to the present invention in use; and

FIG. 2b is a view from below the apparatus of FIG. 2a.

FIGS. 1a and 1b illustrate first apparatus 20 in accordance with the present invention in use when placed on an object such as a roof R of a vehicle V (FIG. 1), such as an emergency vehicle, for example a police car or the like. The apparatus 20 comprises magnetic means in the form of a magnet 22 which is spaced from the surface of the roof R by resilient spacer means in the form of an “O” ring sealing member 24. The magnet 22 is connected to an article such as a light or siren 28 used by emergency services such that the light or siren 28 can be mounted on a vehicle V as required.

The use of the “O” ring sealing member 24, which is constructed from resilient material such as rubber, suitable elastomeric material or the like, enables the magnet 22 to be spaced from the roof R whilst still retaining strong magnetic pull between the magnet 22 and the vehicle roof R. The arrangement of the resilient member 24 is an important aspect of the present invention and is chosen to enable the apparatus 20 to be selectively removed from magnetic mounting on an object whilst mitigating the likelihood of removal causing damage or significant damage thereto, and not significantly adversely affecting the magnetic attraction of the apparatus to the vehicle V.

Furthermore, the member 24 acts to secure attachment as air can be forced out from between the magnet 22 and the vehicle roof R thereby further enabling the apparatus 20 to be securely attached onto the roof R by suction. The “O” ring sealing member 24 is received in a recess 26 extended around the periphery base 30 of the magnet 22.

The magnetic means 22 comprises an inner part 22a and an outer part 22b which defines a recess 32 in which the inner part 22a fits to be substantially central in the base 30. An annular air gap 34 extends around the inner part 22a between said part 22a and the outer part 22b.

The inner part 22a comprises a rare earth metal magnet such as neodymium iron boron and presents a first magnet pole (either North or South), illustrated as South, on the base 30.

The outer part 22b comprises a cup of mild steel which assumes magnetic properties from the flux of the inner part 22a to present the appropriate pole, in this example North, at the base 30. The magnetic flux is very concentrated therefore across the gap 34 to give the apparatus 10 a very strong magnetic pull onto a metallic object such as a vehicle V.

This strong attraction can be the cause of problems of damage to an object during removal of the apparatus 10 from mounting. The resilient member 24 mitigates such problems.

The apparatus 20 as described above is therefore sufficiently secure for its intended use but selectively removable from the roof 26 when required, for example when an emergency is no longer occurring.

The “O” ring sealing member 24 is provided around the periphery of the magnet 22 such that maximum magnetic pull is achieved between the magnet 22 and the roof R by maximising the surface area of the magnet 22 which faces the roof R.

FIGS. 2a and 2b illustrate a further embodiment of the present invention in which the resilient means 122 in the form of an “O” ring 36 is provided in the air gap 134.

The features of this embodiment are of the same nature as those described above for the first embodiment and therefore have been referenced with the same numbering prefixed ‘1’.

The location of resilient means 122 in the gap 124 provides for a simpler design of apparatus 180. The means 122 must be non-metallic so as not to adversely affect the magnetic flux across the gap and hence the magnetic forces of the means 122.

Accordingly, the apparatus 20, 120 of the present invention enables an object such as a siren or light to be removably attached to the roof R of a vehicle as required by a user. The provision of resilient means 24, 124 enables the magnetic means 22, 122 to be spaced from the roof R wilst still retaining strong magnetic forces therebetween and also provide for additional suction forces between the roof and the magnet to occur.

The apparatus 20, 120 according to the present invention may also be used for attaching other auricles onto metallic surfaces such as bodies of vehicles. Such articles may include aerials for radios or for mobile phones.

Many variations and modifications can be made to the apparatus described above without departing from the scope of the present invention. Furthermore, the resilient means may be removably attachable to the magnetic means thereby enabling simple replacement when required due to wear and tear. Alternatively the resilient members could be in the form of a number of annular elements extending from the magnetic means

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. Magnetic apparatus removably mountable on an object, the apparatus comprising magnetic means and resilient means on the magnetic means to space the magnetic means from the object.

2. Magnetic apparatus as claimed in claim 1, in which the resilient means is arranged to present no significant reduction in the surface area of the magnet means acting on the object.

3. Magnetic apparatus as claimed in claim 1 or claim 2, in which the resilient means is arranged to space the magnetic means from an object just sufficient to facilitate selective removal of the apparatus from an object, whilst allowing the magnetic forces acting to hold the apparatus on an object to remain sufficient to hold the apparatus in position on an object for use.

4. Magnetic apparatus as claimed in any preceding claim, in which the resilient means is arranged to provide for selective removal of apparatus from an object whilst acting to mitigate the possibility of damage to the object.

5. Magnetic apparatus as claimed in any preceding claim, in which the resilient means is attached to the magnetic means.

6. Magnetic apparatus as claimed in claim 5, in which the resilient means is removably attached.

7. Magnetic apparatus as claimed in any preceding claim, in which the resilient means comprises a sealing member.

8. Magnetic apparatus as claimed in any preceding claim, in which the sealing member is in the form of an “O” ring.

9. Magnetic apparatus as claimed in any preceding claim, in which the resilient means is located in use at or near to the periphery of a surface of the magnetic means which in use faces an object.

10. Magnetic apparatus as claimed in any of claims 1 to 8, in which the sealing member comprises one or more annular sealing members extending from within said surface of the magnetic means.

11. Magnetic apparatus as claimed in any preceding claim, in which a recess or other suitable formation is provided in the magnetic means to receive the resilient means.

12. Magnetic apparatus as claimed in any of claims 9 to 11, in which the said surface of magnetic means comprises a central part comprising a magnetic pole, with an outer part spaced from the central part and comprising the opposite magnetic pole.

13. Magnetic apparatus as claimed in claim 12, in which the central part and outer part are concentric.

14. Magnetic apparatus as claimed in claim 12 or claim 13, in which the said recess is defined between said central and outer parts.

15. Magnetic apparatus as claimed in any preceding claim, in which the magnetic means comprises a rare earth magnetic material.

16. Magnetic apparatus as claimed in claim 15, in which the magnetic means is neodymium iron boron.

17. Magnetic apparatus as claimed in any preceding claim, in which the apparatus further includes means for connecting an article to be mounted to the apparatus.

18. Magnetic apparatus as claimed in claim 17, in which the article is removably connected to the apparatus.

19. Magnetic apparatus as claimed in claim 17, in which the article is permanently connected to the apparatus.

20. Emergency indication apparatus, the apparatus comprising magnetic means according to any of the preceding claims and emergency indication means.

21. Emergency indication apparatus as claimed in claim 20 in which the emergency indication means are in the form of an article such as a light or siren.

22. Emergency indication apparatus as claimed in claim 20 or claim 21, in which the emergency indication means are releasably connected to the magnetic apparatus.

23. Emergency indication apparatus as claimed in any of claims 20 to 22, in which the emergency indication means are releasably mountable onto an object such as the body of a vehicle.

24. Emergency indication apparatus as claimed in any of claims 20 to 24, in which the apparatus is mountable onto a vehicle.

25. Magnetic apparatus substantially as hereinbefore described with reference to the accompanying drawings.

26. Emergency indication apparatus substantially as hereinbefore described with reference to the accompanying drawings.

27. Any novel subject matter or combination including novel subject matter disclosed herein, whether or not within the scope of or relating to the same invention as any of the preceding claims.
